(19) United States
(12) Patent Application Publication
(10) Pub. No.: US 2015/0077230 A1
(43) Pub. Date: Mar. 19, 2015

(54) Protection System for Instrument Service and Calibration

(71) Applicant: Rocco D. Pochy, Milpitas, CA (US)

(72) Inventor: Rocco D. Pochy, Milpitas, CA (US)

(21) Appl. No.: 14/486,760

(22) Filed: Sep. 15, 2014

Related U.S. Application Data
(60) Provisional application No. 61/877,869, filed on Sep. 13, 2013.

(51) Int. Cl. G08C 17/02; G06K 7/00

(52) U.S. Cl. CPC G08C 17/02; G06K 7/0008; G06K 2007/10524
USPC 340/10.4

(57) ABSTRACT

A system designed to maintain calibration and protect the location-based data acquired in measurements performed with a precise instrument. The system of the present invention is preferably implemented via an instrument that includes an RFID system. The RFID reader is preferably integrated into the measurement instrument itself, and is capable of reading RFID tags that are proximal to the instrument or are affixed to location information encoded within the RFID tags.

### CONTINUITY

This application is a non-provisional application of provisional application No. 61/877,869, filed on Sep. 13, 2013 and priority is claimed thereto.

### FIELD OF THE PRESENT INVENTION

The present invention relates to protection systems, and more specifically, those designed to protect instruments and maintaining the precise calibration of said instruments, especially concerning the calibration of location data associated with a tag identification number.

### BACKGROUND OF THE PRESENT INVENTION

In large installations of remote sensors, there are times to replace or calibrate the instruments or the sensor itself. Common in most bus based units, the device address may be used as a reference to the location of the sensor. This does system does not work if the sensor is moved and the addressing of the sensor location is not updated. The system will collect data assigned to the wrong physical location of the sensor. Having a user interface to set a location value is prone to user error. The ability to assure that the placement of a remote sensor will always provide the accurate location information would assure seamless and correct mapping of sensor data to a location.

### Portable Instruments

In some applications, the need to repetitiously take measurements with portable instruments at several locations is required or mandated. The usual method employed includes placing the instrument equipped with a sensor at a pre-defined location, entering the location into the instrument, and then collecting the data. This process is repeated multiple times over the area of interest, and can be time consuming. The problem with this method is that the process demands the operator to update the location at which the data is collected so that the data is mapped to the correct location regardless of if the instrument has been moved. By using a tag at each pre-defined location and a reader built into the instrument, this process can be automated to assure accurate recording of data at the locations prescribed.

### Remote Sensors

Remote Sensors are usually installed at fixed locations in the area of interest. Data is conventionally collected from each location based on a unique value assigned to each remote sensor. A protocol address is usually used to identify the remote sensor, which is then mapped to a location. The problem with using unique IDs associated with a remote sensor is that if the remote sensor is moved from its pre-defined location, the location is not updated. The monitoring system is unaware of the new location and thus, attributes the data to the incorrect location. Another issue occurs during calibration or replacement of the remote sensor. Unless the appropriate changes are made in the remote sensor (resetting the addressing manually or mapping), the data collected will be attributed to the incorrect location, causing measurements to be improperly calibrated to the location.

Thus, there is a need for an accurate system by which location data of remote sensors and instruments can be easily maintained and calibrated, such that measurements are protected against error, and the process is expedited and streamlined.

Patent publication No. US2006/0267731 A1 is for a System and Apparatus of Internet-linked RFID Sensor Network For Object Identifying, Sensing, Monitoring, Tracking, and Networking, published on Nov. 30, 2006, by Chen. Chen differs from the present invention in that the sensors that are employed by Chen are tagged with wireless tags, RFID tags, or RFID-Integrated tags which are monitored by a reader mount to track these sensors objects. The present invention defines the tag as a location with the sensor using a RFID reader to record the RFID tag as a indication of location within the limited range of the reader.

U.S. Pat. No. 7,636,031, granted to Mirmobin et al. and issued on Dec. 22, 2009, is for a Sensor System Including Multiple Radio Frequency Identification Tags. Mirmobin et al features a sensor that contains RFID tags that can be read by an RFID reader to pass information from the sensor through the tags. Whereas the present invention reads the location information at the location of the tags to the sensor on-board the instrument, and the instrument assigns and maintains the location data to the measurements gathered.

There is a need for a sensor/indicator system that allows sensors or instruments to be moved, placed in a different location, and automatically updated with the new location of where the data is being collected. By using a RFID tag at each pre-defined location, and an RFID reader built into the instrument, this process can be automated to assure accurate recording of data at the locations prescribed.

### SUMMARY OF THE PRESENT INVENTION

The present invention is a protection system for calibrated instruments that are designed to gather data from measurements taken at location-sensitive positions. As such, the present invention employs the use of a conventional RIFD reader in order to assign a location to an RFID tag for tracking and monitoring purposes of data acquired at that location.

A data collection instrument equipped with the present invention contains a conventional RFID reader. When the instrument is used to take a measurement, an RFID tag is read by the RFID reader at the location the measurement is taken at. The instrument then assigns the measurement to the location, and associates it with the RFID tag number located proximal to the location of measurement. It is the intent of the present invention to ensure data that is gathered via a sensor is mapped to the correct location, regardless of if the RFID tag location is changed.

The present invention is configured with a RFID reader integrated into the data sensor itself, onboard an instrument. It is configured to read a proximal RFID tag containing an identification number, which is then associated with that specific location. The location of the RFID tag attained and assigned to the RFID by a GPS based or grid system based location device, and need not be incorporated into the data collection instrument equipped with the present invention. By having a RFID tag that is fixed to the location of interest, when the remote sensor is place in its proximity, the sensor will register its location and include that tag value as part of its data stream. If the sensor data does not register a location tag, the operator can be made aware of the issue and corrective actions can be taken.

The present invention is unique in that the sensor itself contains the RFID reader that can read a single RFID tag in a limited range, in order to assign a location to that sensor based on the RFID tag.

### BRIEF DESCRIPTION OF THE DRAWINGS

FIG. 1 shows a flow chart of the process of use of the system of the present invention.

### DETAILED DESCRIPTION OF THE PREFERRED EMBODIMENT

The present invention is a system for protecting the precise calibration of location data, designed to ensure that all measurements made with an instrument are associated with the correct location—even in the event that the location has changed. The aim of the present invention is accomplished via a RFID system—including an RFid reader and an RFid tag, integrated into a calibrated instrument or system of instruments. An external GPS device or other grid-based location system is preferably employed to establish the location of the RFid tag upon placement.

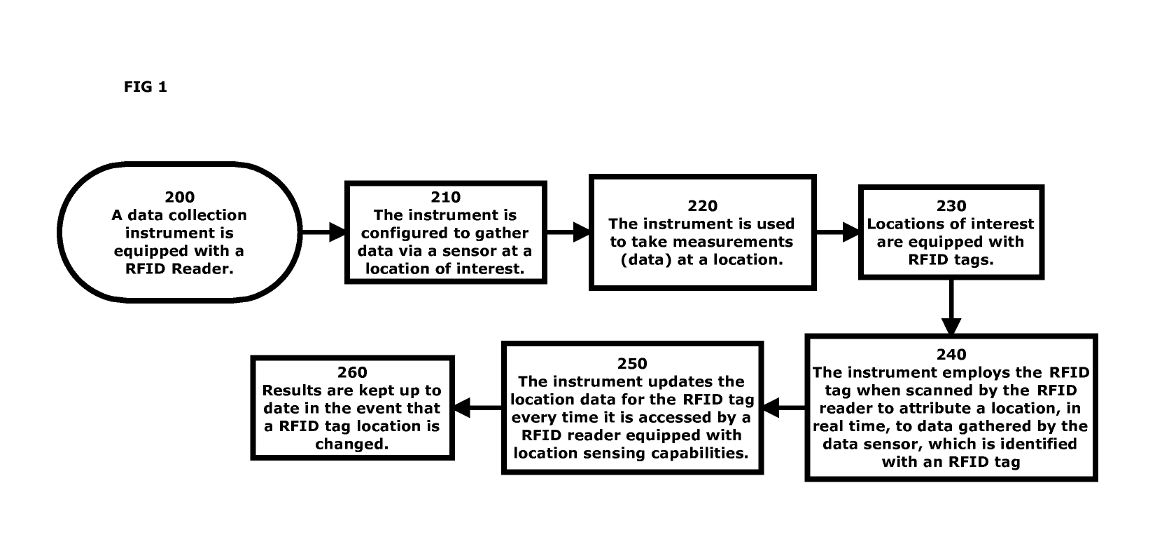

FIG. 1 displays the process of the present invention. Initially, an instrument is equipped with a conventional RFID reader (200). The instrument is configured to gather data via a sensor (such as a remote sensor) at a location of interest (210). The instrument is used to take measurements (amounting to data) at a specific location (220). Locations of interest are preferably equipped with RFID tags (230). The instrument employs the RFID tag when scanned by the RFID reader to attribute a location, in real time, to data gathered by the data sensor, which is identified with an RFID tag (240). The instrument updates the location data for the RFID tag every time it is accessed by a RFID reader equipped with location sensing capabilities (250). The resulting data and location information attributed to the results are then kept up to date in the event that a RFID tag location is changed (260).

One use of the present invention is through the use of posted indicators or alarm towers which are associated with a given area. Based on the data collected in that area, the appropriate triggers are set for the indicator. It is crucial that the location data is kept correct in order to provide an accurate indication of the state of the area.

The preferred implementation of the system of the present invention is the use of RFID tags which are placed at the locations of interest—places from where sensory data is desired. RFID readers are preferably built into the instrument. When the instrument is placed within the range of the RFID tag, the reader reads the location of the tag, preferably either by its association with a location within a grid, GPS, or other sensitive indoor location technology, and updates the location information with the data collected. Moving or replacing sensors would allow automatic updates of the location of where the data is being collected, in real time. In this manner, the precise location of the tag, as well as the corresponding measurements taken at the position of the RFID tag, are kept up to date, even if the RFID tag is moved. This is because the location of the RFID tag is updated each time it is accessed or read by the RFID reader equipped by the instrument taking measurements.

I claim:

1. A method for protecting the calibration of location data comprising:
equipping an instrument with an RFID reader;
wherein the instrument is portable;
equipping the instrument with location sensing capabilities;
transporting the instrument to a location of interest, the location of interest is equipped with a RFID tag;
wherein the location of interest is equipped with a sensor configured to provide data to the instrument;
the instrument scanning the RFID tag with the RFID reader;
the instrument sensing location coordinates;
attributing the data to the location coordinates; and
updating the location coordinates of the RFID tag in accordance with the location coordinates.
